(19) United States
(12) Patent Application Publication
(10) Pub. No.: US 2025/0334550 A1
(43) Pub. Date: Oct. 30, 2025

(54) NON-DESTRUCTIVE INSPECTION METHOD AND SYSTEM BASED ON SELF-SUPERVISED LEARNING

(71) Applicants: KOREA RESEARCH INSTITUTE OF STANDARDS AND SCIENCE, Daejeon (KR); GWANGJU INSTITUTE OF SCIENCE AND TECHNOLOGY, Gwangju (KR)

(72) Inventors: Jong Moon HA, Daejeon (KR); Won Jae Choi, Daejeon (KR); Hyun Seok Oh, Gwangju (KR); Min Su Jeon, Seoul (KR); Min Seok Choi, Gwangju (KR)

(21) Appl. No.: 19/194,264

(22) Filed: Apr. 30, 2025

(30) Foreign Application Priority Data
Apr. 30, 2024 (KR) 10-2024-0057794

(51) Int. Cl. G01N 29/06; G01N 29/40

(52) U.S. Cl. CPC G01N 29/069; G01N 29/40

(57) ABSTRACT

Disclosed is a non-destructive inspection method and system based on self-supervised learning, which detect the inside of an inspection object in a non-destructive way by using ultrasonic waves and also predict the depth of a defect through self-supervised learning. According to the non-destructive inspection method, it is possible to predict whether a defect is present within an inspection object and the depth of the inspection object in a non-destructive learning way, by augmenting a floor reflected signal into which physical characteristics of a defect reflected signal are incorporated through random scaling, applying an arbitrary defect signal to a random location, and determining whether a defect is present based on an average of the absolute values of a defect prediction signal and a statistical threshold by training a model in a way to remove the arbitrary defect signal through the structure of the denoising autoencoder.

### BACKGROUND

### 1. Technical Field

The present disclosure relates to a non-destructive inspection method, and particularly, to a non-destructive inspection method and system based on self-supervised learning, which detect the inside of an inspection object in a non-destructive way by using ultrasonic waves and also predict the depth of a defect through self-supervised learning.

### 2. Related Art

Ultrasonic inspection is widely used in various industry fields because the ultrasonic inspection has an advantage in that it can detect a defect within an inspection object in a non-destructive way. In particular, the ultrasonic inspection is also used in a site in which a welding defect or the corrosion of a pipe has to be detected as in a nuclear power plant. However, inaccurate ultrasonic inspection fails in detecting an internal defect, which may lead to great damage to a system. Accordingly, accurate detection of defects by means of ultrasonic inspection is considered to be of critical importance.

Furthermore, the ultrasonic inspection needs to obtain data in a limited environment, and has a problem in that the results of the inspection are different depending on an inspector. In order to solve such a problem, research is being conducted to introduce the artificial intelligence (AI) technology into ultrasonic inspection.

Conventionally, in most of research in which AI has been introduced into the ultrasonic inspection field, data are pre-processed or the type of defect is predicted through a classification model. To this end, labeling data for various types of defects are required.

In particular, upon ultrasonic inspection to which AI has been applied, the ultrasonic inspection is sensitive to a sample surface state and requires separate label data. However, for AI training, it may be said that it is almost impossible to obtain the same state of a sample as an inspection object and to obtain label data in an acquisition environment.

### PRIOR ART DOCUMENT

### Patent Document

(Patent Document 1) Korean Patent No. 10-2497000 (Feb. 28, 2023)

### SUMMARY

Various embodiments are directed to embodying a non-destructive inspection method and system based on self-supervised learning using a method of synthesizing abnormal signals based on only a measured signal in order to solve a problem that is related to near-surface defect detection work when separate label data cannot be used.

In an embodiment, a non-destructive inspection system based on self-supervised learning may include a data pre-processing unit configured to generate a data set including an original signal generated by scanning a sample and an arbitrary defect signal synthesized with the original signal, a defect analysis model including a denoising autoencoder that is trained to receive the plurality of data sets and to output an original signal from which the defect signal has been removed, a residual layer unit configured to output a defect signal through a residual operation of the original signal output by the defect analysis model and input scan data for an inspection object as the scan data are input to the defect analysis model for which training has been completed, and a defect prediction unit configured to predict a location and depth of a defect on the inspection object by applying a statistical threshold to the defect signal.

The data pre-processing unit may generate the data set by augmenting a reflected signal generated with respect to a corresponding floor when ultrasonic waves are radiated toward the sample.

The data pre-processing unit may augment the reflected signal by changing amplitude of the reflected signal through a random scaling factor, and may synthesize the reflected signal with a random location of the scan data.

The denoising autoencoder may include an encoder configured to receive and compress the scan data including the original signal “x” and the defect signal “y” added to the original signal “x” in a cutpaste way and a decoder configured to output a compressed vector “z” as output data having a size identical with the size of the scan data.

The loss function of the denoising autoencoder may be represented as an equation below.

$${min}_{φ , ψ} ( ℒ ) = {min}_{φ , ψ} ( \vert {g}_{ψ} \{ {f}_{φ} ( x + y ) \} - x \vert + \vert ( x + y - {g}_{ψ} \{ {f}_{φ} ( x + y ) \} - y \vert ) = {min}_{φ , ψ} ( \vert {g}_{ψ} \{ {f}_{φ} ( x + y ) \} - x \vert )$$

wherein “x” denotes the original signal. “y” denotes the defect signal. “x+y” denotes a signal to which the defect is arbitrarily applied. “f” denotes the encoder. “g” denotes the decoder. “p and ø” denote parameters of the encoder and the decoder, respectively).

The defect prediction unit may calculate an average of absolute values of the defect signal, and may determine the defect signal to be the defect when the calculated average of the absolute values is greater than a statistical threshold “μ+3σ”.

The defect prediction unit may calculate the depth of the defect through time of flight (TOF) with respect to the defect signal determined as the defect. The TOF may be calculated by an equation below.

$$TOF = arg max ( \vert ( x - {g}_{ψ} ( {f}_{φ} ( x ) ) \vert ) .$$

Furthermore, in an embodiment, a non-destructive inspection method based on self-supervised learning may include generating a plurality of data sets each including an original signal generated by scanning a sample and an arbitrary defect signal assigned to the original signal, training a defect analysis model including a denoising autoencoder so that the defect analysis model outputs an original signal from which the defect signal has been removed by inputting the plurality of data sets to the defect analysis model, outputting a defect signal through a residual operation of the original signal output by the defect analysis model and input scan data for an inspection object by inputting the scan data to the defect analysis model for which training has been completed, and predicting a location and depth of a defect on the inspection object by applying a statistical threshold to the defect signal.

The generating of the plurality of data sets each including the original signal generated by scanning the sample and the arbitrary defect signal assigned to the original signal may include generating a reflected signal of a corresponding floor by radiating ultrasonic waves toward the sample, augmenting the reflected signal by changing amplitude of the reflected signal through a random scaling factor, and synthesizing the reflected signal with a random location of the scan data.

The denoising autoencoder may include an encoder configured to receive and compress the scan data including the original signal “x” and the defect signal “y” added to the original signal “x” in a cutpaste way and a decoder configured to output a compressed vector “z” as output data having a size identical with the size of the original signal.

The loss function of the denoising autoencoder may be represented as an equation below.

$${min}_{φ , ψ} ( ℒ ) = {min}_{φ , ψ} ( \vert {g}_{ψ} \{ {f}_{φ} ( x + y ) \} - x \vert + \vert ( x + y - {g}_{ψ} \{ {f}_{φ} ( x + y ) \} - y \vert ) = {min}_{φ , ψ} ( \vert {g}_{ψ} \{ {f}_{φ} ( x + y ) \} - x \vert )$$

wherein “x” denotes the original signal. “y” denotes the defect signal. “x+y” denotes a signal to which the defect is arbitrarily applied. “f” denotes the encoder. “g” denotes the decoder. “φ and ø” denote parameters of the encoder and the decoder, respectively.

The predicting of the location and depth of the defect on the inspection object by applying the statistical threshold to the defect signal may include calculating an average of absolute values of the defect signal, and determining the defect signal to be the defect when the calculated average of the absolute values is greater than a statistical threshold “μ+3σ”.

The non-destructive inspection method may further include calculating the depth of the defect through time of flight (TOF) with respect to the defect signal determined as the defect, after the determining of the defect signal to be the defect when the calculated average of the absolute values is greater than the statistical threshold “μ+3σ”.

The TOF may be calculated by an equation below.

$$TOF = arg max ( \vert ( x - {g}_{ψ} ( {f}_{φ} ( x ) ) \vert ) .$$

According to the non-destructive inspection method based on self-supervised learning according to an embodiment of the present disclosure, it is possible to predict whether a defect is present within an inspection object and the depth of the inspection object in a non-destructive learning way, by augmenting a floor reflected signal into which physical characteristics of a defect reflected signal are incorporated through random scaling, applying an arbitrary defect signal to a random location, and determining whether a defect is present based on an average 41 absolute values of a defect prediction signal and a statistical threshold by training a model in a way to remove the arbitrary defect signal through the structure of the denoising autoencoder.

### BRIEF DESCRIPTION OF THE DRAWINGS

FIG. 1 is a diagram illustrating the structure of a non-destructive inspection system based on self-supervised learning according to an embodiment of the present disclosure.

FIG. 2 is a schematic diagram of the entire work process of the non-destructive inspection system based on self-supervised learning according to an embodiment of the present disclosure.

FIG. 3 is a schematic diagram of a method of generating a defect signal according to a data pre-processing process.

FIG. 4 is a schematic diagram of a signal processing structure of a defect analysis model and residual layer unit of the non-destructive inspection system based on self-supervised learning according to an embodiment of the present disclosure.

FIG. 5 is a diagram illustrating a non-destructive inspection method based on self-supervised learning according to an embodiment of the present disclosure.

FIG. 6 is a diagram exemplifying signal waveforms in the training and prediction processes of the defect analysis model of the non-destructive inspection system based on self-supervised learning according to an embodiment of the present disclosure.

FIG. 7A and FIG. 7B are a diagram exemplifying conventional B-scan signal waveforms that are collected from an inspection object and B-scan signal waveforms of a system according to an embodiment of the present disclosure.

FIG. 8A and FIG. 8B are a diagram for describing a defect depth prediction method according to an output signal of the non-destructive inspection system based on self-supervised learning according to an embodiment of the present disclosure.

### DETAILED DESCRIPTION

Hereinafter, the present disclosure is described in detail with reference to the accompanying drawings and embodiments.

It is to be noted that technological terms used in the present disclosure are used to describe only specific embodiments and are not intended to limit the present disclosure. Furthermore, the technological terms used in the present disclosure should be construed as having meanings that are commonly understood by those skilled in the art to which the present disclosure pertains unless especially defined as different meanings otherwise in the present disclosure, and should not be construed as having excessively comprehensive meanings or excessively reduced meanings. Furthermore, if the technological terms used in the present disclosure are wrong technological terms that do not precisely represent the spirit of the present disclosure, they should be replaced with technological terms that may be correctly understood by those skilled in the art and understood. Furthermore, common terms used in the present disclosure should be interpreted in accordance with the definition of dictionaries or in accordance with the context, and should not be construed as having excessively reduced meanings.

Furthermore, an expression of the singular number used in this specification includes an expression of the plural number unless clearly defined otherwise in the context. In this application, terms, such as “include” and “comprise”, should not be construed as essentially including all various components or various steps described in the specification, but the terms may be construed as not including some of the components or steps or as including additional components or steps.

Furthermore, terms including ordinal numbers, such as a “first” and a “second”, which are used in the present disclosure, may be used to describe various components, but the components are not restricted by the terms. The terms are used to only distinguish one component from the other components. For example, a first component may be named a second component without departing from the scope of rights of the present disclosure. Likewise, the second component may be named the first component.

Furthermore, in describing the present disclosure, a detailed description of a related known technology will be omitted if it is deemed to make the subject matter of the present disclosure unnecessarily vague. Furthermore, the accompanying drawings are merely intended to make easily understood the spirit of the present disclosure, and the spirit of the present disclosure should not be construed as being restricted by the accompanying drawings.

Hereinafter, embodiments according to the present disclosure are described in detail with reference to the accompanying drawings. The same or similar component is assigned the same reference numeral regardless of its reference numeral, and a redundant description thereof is omitted.

In the following description, an “inspection system” or a “system” may be interchangeably used as a term that denotes a non-destructive inspection system based on self-supervised learning according to an embodiment of the present disclosure.

Hereinafter, a non-destructive inspection system and method based on self-supervised learning according to embodiments of the present disclosure are described in detail with reference to the accompanying drawings.

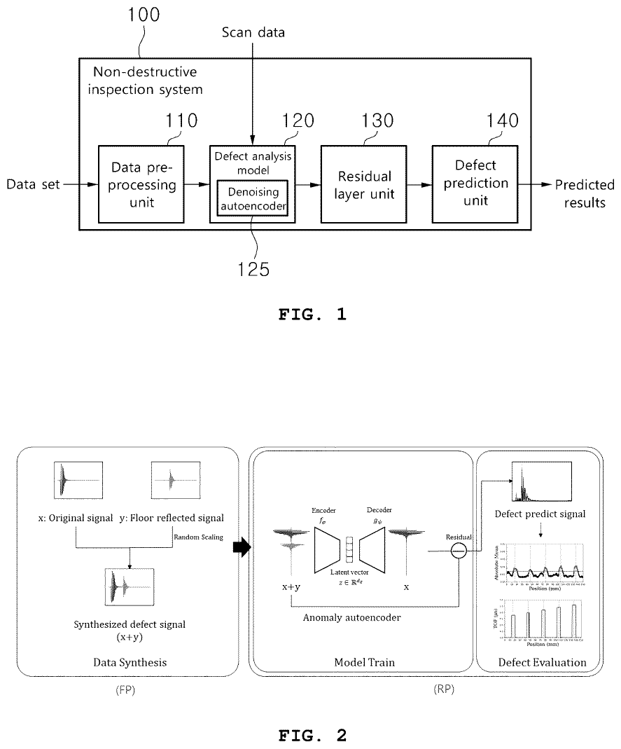

FIG. 1 is a diagram illustrating the structure of a non-destructive inspection system based on self-supervised learning according to an embodiment of the present disclosure.

Referring to FIG. 1, the non-destructive inspection system 100 based on self-supervised learning according to an embodiment of the present disclosure may include a data pre-processing unit 110 that generate a data set including an original signal generated by scanning a sample and an arbitrary defect signal synthesized with the original signal, a defect analysis model 120 including a denoising autoencoder 125 that is trained to receive the plurality of data sets and to output an original signal from which the defect signal has been removed, a residual layer unit 130 that outputs a defect signal through a residual operation of the original signal output by the defect analysis model and input scan data for an inspection object as the scan data are input to the defect analysis model for which training has been completed, and a defect prediction unit 140 that predicts the location and depth of a defect on the inspection object by applying a statistical threshold to the defect signal.

An inspection procedure by the system 100 according to n embodiment of the present disclosure may be basically divided into a forward process of converting an original signal into a defect signal and a reverse process of predicting a defect by converting the defect signal into an original signal. The data pre-processing unit 110 may perform the forward process. The defect analysis model 120, the residual layer unit 130, and the defect prediction unit 140 may perform the reverse process.

The data pre-processing unit 110 may generate a defect signal for an original signal that is obtained through ultrasonic scan for a sample so that a data set for training is prepared.

According to an embodiment of the present disclosure, a defect signal may be obtained by performing ultrasonic inspection on a sample using a pulse-echo method. A data set for training may be generated by using the defect signal.

Specifically, a one-dimensional signal obtained by collecting signals that are returned after ultrasonic waves are emitted from one point and reflected is called A-scan. The data pre-processing unit 110 may apply a defect to the one-dimensional A-scan signal by applying a cutpaste scheme.

In particular, when the defect signal is generated, not a random part of the defect signal, but only a floor reflected signal may be used. As physical characteristics of the floor reflected signal are shared with a signal reflected in an actual defect, the floor reflected signal may incorporate an equipment setting value or information on an acquisition environment. Accordingly, a defect may be applied by using the floor reflected signal.

Furthermore, the data pre-processing unit 110 may augment the reflected signal. The cutpaste scheme is to augment data by using a method of changing the brightness and chroma of a patch or rotating the patch, which enables various types of discontinuities to be learnt. A converted A-scan signal may be different depending on the moving speed or surface state of a problem upon actual ultrasonic inspection.

The data pre-processing unit 110 according to an embodiment of the present disclosure may change the time when an original signal is linearly increased through random scaling and the amplitude or location of a peak by changing an amplitude axis into a random curve through the cutpaste scheme. That is, the system 100 according to an embodiment of the present disclosure may perform the learning of defects having various forms or sizes by augmenting data without damaging physical information of a sample.

The defect analysis model 120 may be trained through data sets prepared by the data pre-processing unit 110. After the training of the defect analysis model 120 is completed, the defect analysis model 120 may predict a defect receiving ultrasonic scan data of an inspection object.

To this end, the defect analysis model 120 includes an autoencoder that outputs only an original signal from data including a defect signal that is applied in the training step. The denoising autoencoder 125 that receives data to which an arbitrary defect has been added by the data pre-processing unit 110 and that outputs data before noise is added may be used as the autoencoder.

In particular, the denoising autoencoder 125 according to an embodiment of the present disclosure is implemented to have a structure that receives data in which a signal reflected and augmented by the data pre-processing unit 110 is added as a defect signal and that removes the defect signal, unlike in a method of a known denoising autoencoder receiving data to which random noise has been added and outputting data before the random noise is added.

Furthermore, the residual layer unit 130 may output only a defect signal through a residual operation of an original signal, that is, output data output by the defect analysis model 120, and an original signal that is input data and a defect signal.

Furthermore, the defect prediction unit 140 may predict a defect for an inspection object by using a defect signal as scan data for the inspection object is input to the trained defect analysis model 120. The defect signal may be indicated as an average distribution of the absolute values of the defect signal. A normal distribution including values close to 0 and a defect distribution including a specific value are mixed in the average distribution. Accordingly, assuming that the defect signal is a Gaussian mixture distribution, a distribution having the smallest average may be considered as the normal distribution. A statistical threshold, for example, “μ+3σ” is set based on an average and standard deviation of the normal distribution. When an average of the absolute values of an output defect signal is greater than the statistical threshold, the output defect signal may be determined to be a defect.

Furthermore, the depth of the defect may be determined by calculating time of flight (TOF) with respect to the detect signal determined to be a defect.

According to the above structure, the non-destructive inspection system based on self-supervised learning according to an embodiment of the present disclosure embodies a non-destructive defect diagnosis function capable of detecting an internal defect without destructing a structure by using ultrasonic waves, but can embody a defect inspection solution that surpasses performance of the existing time domain gate-based inspection, a (common) autoencoder-based inspection, and BeatGAN and DRAEM models by applying a method of augmenting a floor reflected signal and arbitrarily applying a defect even in a condition in which separate label data cannot be obtained.

Hereinafter, the construction of the non-destructive inspection system based on self-supervised learning according to an embodiment of the present disclosure is described in detail with reference to the drawings.

FIG. 2 is a schematic diagram of the entire work process of the non-destructive inspection system based on self-supervised learning according to an embodiment of the present disclosure.

Referring to FIG. 2, a work process by the non-destructive inspection system based on self-supervised learning according to an embodiment of the present disclosure may be basically divided into a forward process (FP) of preparing data sets for the training of the defect analysis model and a reverse process (RP) of predicting a defect of an inspection object by using the trained defect analysis model.

The forward process (FP) is a procedure of preparing data sets for the training of the defect analysis model, and may include generating a defect signal “x+y” by synthesizing a floor reflected signal “y” of an inspection object with an original signal “x” that is received by radiating ultrasonic waves to a sample.

In this case, the reflected signal “y” is a signal of the radiated ultrasonic waves, which is reflected by the floor of the sample, and is a signal including a patch that is augmented by applying random scaling after a reflected signal is cut according to the cutpaste scheme.

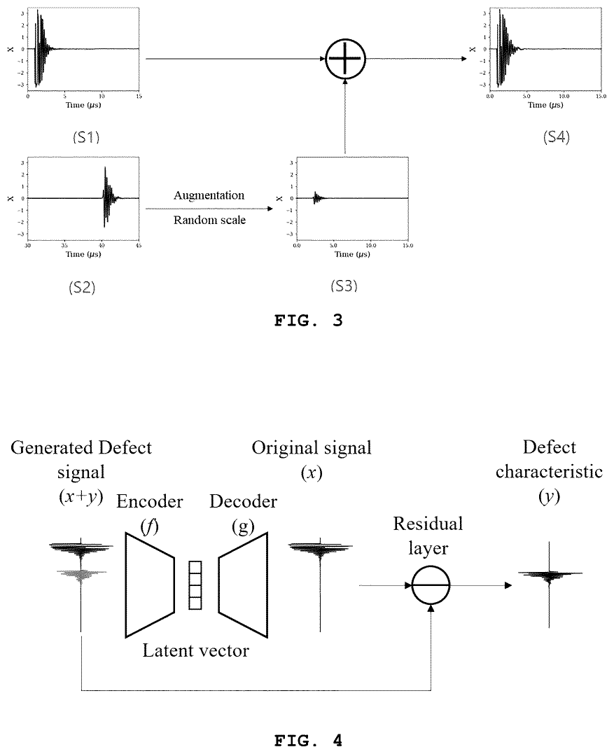

FIG. 3 is a schematic diagram of a method of generating a defect signal according to a data pre-processing process. As described above, an augmented patch {(S1)→(S2)} is pasted at an arbitrary location on an original signal according to the cutpaste scheme {(S1)⊕(S3)→(S4)}. In this case, overlap may occur in a signal having a one-dimensional A-scan form. Accordingly, as described above, the floor reflected signal is augmented through random scaling, and a defect is applied to the original signal in addition to the random location.

A data set having a two-dimensional B-scan form is prepared by collecting the defect signal having the A-scan form by moving a scanner in one direction.

Referring back to FIG. 2, the reverse process (RP) is a procedure of performing training by using the prepared data sets and predicting a defect based on scan data for the inspection object when the training is completed.

Specifically, the reverse process (RP) includes performing training on the denoising autoencoder, extracting only a defect signal through a residual layer unit when scan data are input, and predicting a defect.

In particular, it is important for a learning model for defect prediction to output only a defect signal through end to end without separate retraining or optimization in a speed or convenience aspect upon actual inspection. Furthermore, not a signal reconstruction, but signal conversion needs to be focused. Accordingly, the structure of the denoising autoencoder is applied to the system according to an embodiment of the present disclosure.

The denoising autoencoder may be trained to receive data to which random noise has been added and to output data to which random noise has not been added. To this end, the denoising autoencoder converts a signal to which random noise has been added into a signal before the random noise was added. Such a method is different in that model training is performed by using a method of arbitrarily applying a defect and removing the defect according to an embodiment of the present disclosure, unlike in the structure of a known denoising autoencoder that adds random noise in a network.

To this end, the denoising autoencoder according to an embodiment of the present disclosure may include an encoder that receives and compresses can data including the original signal “x” and the defect signal “y” added to the original signal “x” in a cutpaste way and a decoder that outputs a compressed vector “z” as output data having the same size as scan data.

Furthermore, in the loss function of the denoising autoencoder, the first term is used to convert a generated defect signal into a signal before a defect is introduced. The second term is used to predict an added defect signal.

FIG. 4 is a schematic diagram of a signal processing structure of the defect analysis model and residual layer unit of the non-destructive inspection system based on self-supervised learning according to an embodiment of the present disclosure. Architecture of a learning model that is applied to the reverse process according to an embodiment of the present disclosure may basically include two parts.

Specifically, in the reverse process, when a signal to which a defect has been applied is input, the autoencoder converts the signal into a signal before the defect is applied. A residual layer may output a defect signal through a residual operation of an input and an output.

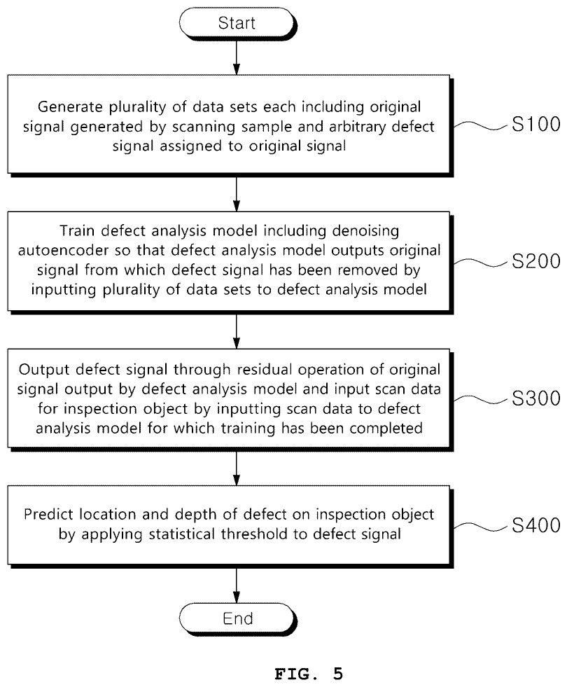

Upon ultrasonic inspection, a signal of ultrasonic waves, which is first reflected and returned by a surface of a sample is called an initial pulse. If a defect signal overlaps such an initial pulse, it is difficult to check whether a defect is present in the same. Accordingly, information on the initial pulse can be removed and only a signal that is reflected and returned by a defect can be output through the construction of the learning model illustrating FIG. 5.

Furthermore, the training of the learning model may be performed by using a loss function according to Equation 1.

$${min}_{φ , ψ} ( ℒ ) = {min}_{φ , ψ} ( \vert {g}_{ψ} \{ {f}_{φ} ( x + y ) \} - x \vert + \vert ( x + y - {g}_{ψ} \{ {f}_{φ} ( x + y ) \} - y \vert ) = {min}_{φ , ψ} ( \vert {g}_{ψ} \{ {f}_{φ} ( x + y ) \} - x \vert ) \qquad ( 1 )$$

In Equation 1, “x” denotes an original signal. “y” denotes a defect signal. “x+y” denotes a signal to which a defect has been arbitrarily applied. “f” denotes the encoder. “g” denotes the decoder. “φ and ø” denote the parameters of the encoder and the decoder, respectively.

Furthermore, the loss functions may be simplified as one term because the first term and the second term have the same equation. The learning model may be trained through one loss function term.

Thereafter, when the model training procedure is completed, the reflected signal of the defect may be obtained by inputting scan data for the inspection object. An average of the absolute values of the reflected signal of the defect may be indicated as a distribution. A normal distribution including values close to 0 and a defect distribution including a specific value are mixed in the distribution. Accordingly, assuming that the distribution is a Gaussian mixture distribution, a distribution having the smallest average, among the Gaussian mixture distributions, refers to the normal distribution.

Accordingly, “μ+3σ” may be set as a statistical threshold by calculating an average and standard deviation of the normal distributions. When an average of the absolute values of the reflected signal of the defect is greater than the statistical threshold, the reflected signal may be determined to be a defect signal.

Furthermore, the depth of the defect may be determined though the time of flight (TOF) of obtained characteristics of the defect. This may be represented like Equation 2.

$$TOF = arg max ( \vert ( x - {g}_{ψ} ( {f}_{φ} ( x ) ) \vert ) . \qquad ( 2 )$$

As described above, in the reverse process according to an embodiment of the present disclosure, whether a defect is present can be predicted based on an average of the absolute values of the defect. A defect within an inspection object can be specified by predicting the depth of the defect through TOF.

Hereinafter, the non-destructive inspection method based on self-supervised learning by the system according to an embodiment of the present disclosure is described with reference to the drawings.

FIG. 5 is a diagram illustrating the non-destructive inspection method based on self-supervised learning according to an embodiment of the present disclosure. In the following description, unless separately described, a subject that executes each step is the non-destructive inspection system based on self-supervised learning according to an embodiment of the present disclosure and the components of non-destructive inspection system.

Referring to FIG. 5, the non-destructive inspection method based on self-supervised learning according to an embodiment of the present disclosure is a non-destructive inspection method for an inspection object using the non-destructive inspection system based on self-supervised learning. The non-destructive inspection method may include step S100 of generating a plurality of data sets each including an original signal generated by scanning a sample and an arbitrary defect signal assigned to the original signal, step S200 of training the defect analysis model including the denoising autoencoder so that the defect analysis model outputs an original signal from which the defect signal has been removed by inputting the plurality of data sets to the defect analysis model, step S300 of outputting a defect signal through a residual operation of the original signal output by the defect analysis model and input scan data for an inspection object by inputting the scan data to the defect analysis model for which training has been completed, and step S400 of predicting the location and depth of a defect on the inspection object by applying a statistical threshold to the defect signal.

In step S100, the data pre-processing unit generates an arbitrary defect signal in the data of a sample for self-supervised learning with respect to an inspection object being in a situation in which multiple data sets cannot be prepared, and prepares a data set by assigning an original signal to the data set.

To this end, the system may perform a step of generating a reflected signal of a corresponding floor by radiating ultrasonic waves to the sample, a step of augmenting the reflected signal by changing amplitude of the reflected signal based on a random scaling factor, and a step of synthesizing the reflected signal with a random location of the original signal.

Next, in step S200, the defect analysis model is trained to output an original signal from which the defect signal has been removed by inputting the prepared data set to the denoising autoencoder. To this end, the encoder may receive and compress scan data including the defect signal “y” added to the original signal “x” in the cutpaste way. The decoder may output the compressed vector “z” as output data having the same size as the scan data.

Next, in step S300, the residual layer unit may output a defect signal through a residual operation of the defect signal output in step S200 and the input scan data. The denoising autoencoder has been trained to output only an original signal from a generated defect signal according to a loss function, and may output only the defect signal through the residual operation of the defect signal synthesized with the original signal and the original signal output by the decoder.

Furthermore, in step S400, a statistical threshold may be set according to the three sigma rule by using the output signal, that is, the average of the absolute values of the defect signal. A defect may be determined in the inspection object on the basis of the statistical threshold. Furthermore, the depth of the defect may be predicted by calculating the TOF of obtained characteristics of the defect.

Hereinafter, a technical spirit according to an embodiment of the present disclosure is described in detail through signal waveforms of input and output signals of the non-destructive inspection system based on self-supervised learning according to an embodiment of the present disclosure.

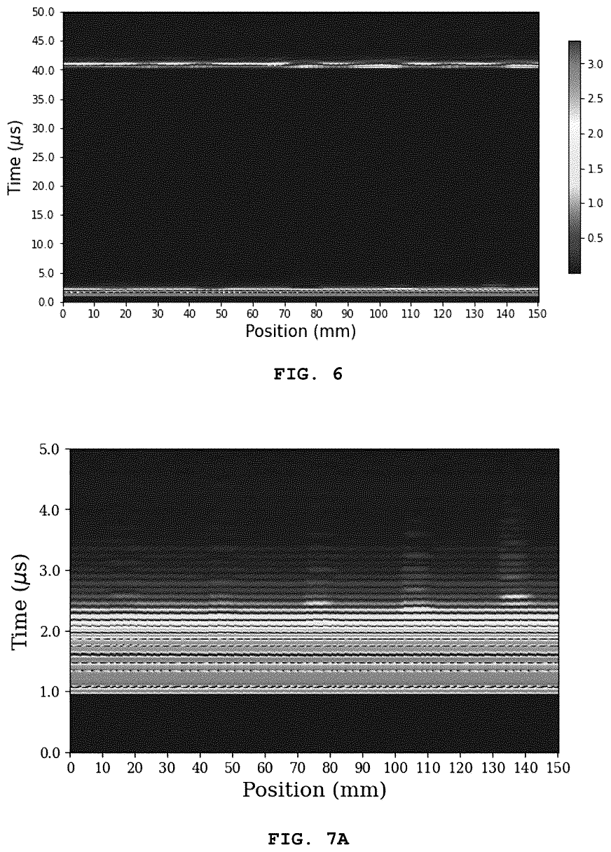

FIG. 6 is a diagram exemplifying signal waveforms in the training and prediction processes of the defect analysis model of the non-destructive inspection system based on self-supervised learning according to an embodiment of the present disclosure.

Referring to FIG. 6, in order to train the defect analysis model, the non-destructive inspection system based on self-supervised learning according to an embodiment of the present disclosure needs to collect multiple data through ultrasonic scan for a sample. To this end, a sampling rate is set to 108 samples/sec, and a probe scans a total of 150 mm of the sample every 2 mm per second.

As a result, A-scan data obtained at one point include 5000 datum points, and the total number of scanned A-scan signals is 751. Furthermore, a B-scan signal is generated by collecting the obtained A-scan data and arranging the collected A-scan data on a two-dimensional plane. Such a B-scan image is illustrated in FIG. 6.

In particular, from FIG. 6, it may be seen that peaks occur at locations at which t is 1 mm to 2 mm. In this case, a peak near t=40 mm, that is, an initial pulse, is a signal of ultrasonic waves that is reflected from and returned by a floor.

In this manner, the sample is set. The B-scan image including normal A-scan data, A-scan data corresponding to a defect, the initial pulse, and a floor reflected signal is obtained.

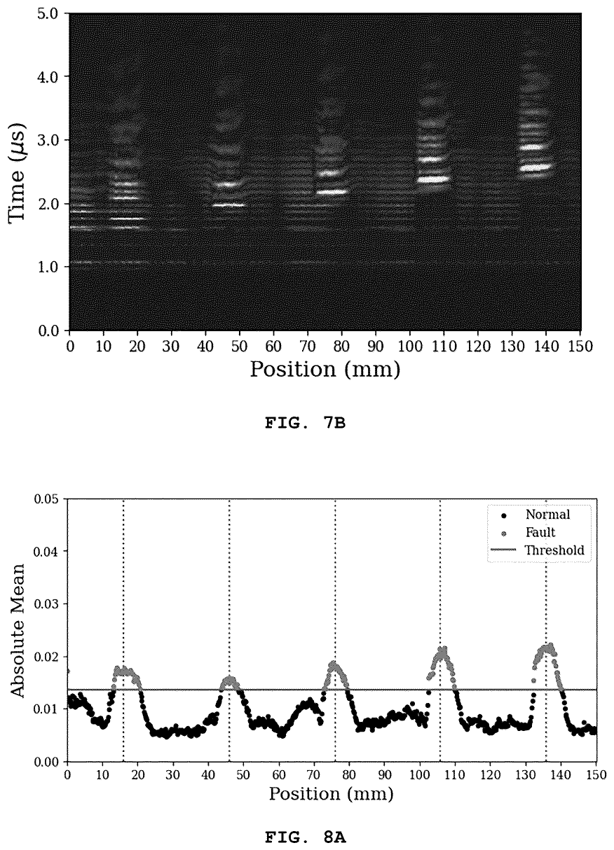

FIG. 7A and FIG. 7B are a diagram exemplifying conventional B-scan signal waveforms that are collected from an inspection object and B-scan signal waveforms of a system according to an embodiment of the present disclosure.

Referring to FIG. 7A, in the existing B-scan image, all of defect characteristics are covered due to an initial pulse that is generated in a region of t=1 micro sec to 2.5 micro see, and only a creeping wave that is repeatedly reflected by the top and bottom of a defect is identified. Accordingly, in the existing B-scan image, it is difficult to predict whether the defect is present or an accurate depth of the defect.

In contrast, Referring to FIG. 7B, in an output signal B-scan image of the system according to an embodiment of the present disclosure, it may be seen that an initial pulse in the region of t=1 micro sec to 2.5 micro sec is removed and the defect characteristics appear.

Accordingly, it is possible for the system according to an embodiment of the present disclosure to qualitatively predict whether a defect is present and the depth of the defect.

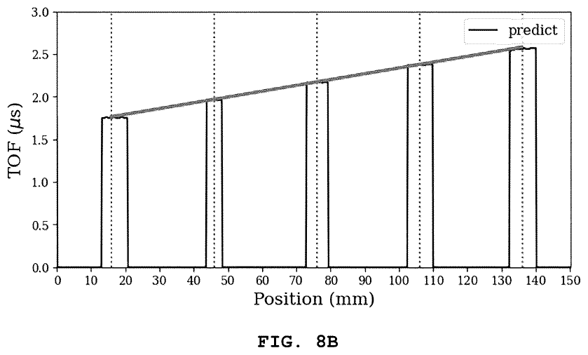

FIG. 8A and FIG. 8B are a diagram for describing a defect depth prediction method according to an output signal of the non-destructive inspection system based on self-supervised learning according to an embodiment of the present disclosure.

FIG. 8A and FIG. 8A illustrate the results of whether a defect is present and the depth of the defect, which were predicted based on output data. In two graphs in FIG. 8A and FIG. 8B, a red vertical dotted line is a region in which an actual defect is placed. From the graph in FIG. 8A, it may be seen that an average distribution of the absolute values of the output signal has a high value near the region in which the actual defect is placed.

Accordingly, the average distribution of the absolute values of the output signal is greater than a statistical threshold only in the region near the defect, and the output signal is determined to be the defect.

Furthermore, the graph in FIG. 8B illustrates the visualized results of the locations of peaks with respect to a defect signal, and illustrates that a location near the red vertical dotted line is predicted as a defect and TOF is linearly increased.

Accordingly, according to the non-destructive inspection method according to an embodiment of the present disclosure, it may be seen that whether a defect is present and the depth of the defect are accurately determined through non-supervised learning.

While various embodiments have been described above, it will be understood to those skilled in the art that the embodiments described are by way of example only. Accordingly, the disclosure described herein should not be limited based on the described embodiments.

### DESCRIPTION OF REFERENCE NUMERALS

100: defect inspection system
110: data pre-processing unit
120: defect analysis model
125: denoising autoencoder
130: residual layer unit
140: defect prediction unit

What is claimed is:

1. A non-destructive inspection system based on self-supervised learning, comprising:
a data pre-processing unit configured to generate a data set comprising an original signal generated by scanning a sample and an arbitrary defect signal synthesized with the original signal;
a defect analysis model comprising a denoising autoencoder that is trained to receive the plurality of data sets and to output an original signal from which the defect signal has been removed;
a residual layer unit configured to output a defect signal through a residual operation of the original signal output by the defect analysis model and input scan data for an inspection object as the scan data are input to the defect analysis model for which training has been completed; and
a defect prediction unit configured to predict a location and depth of a defect on the inspection object by applying a statistical threshold to the defect signal.

2. The non-destructive inspection system of claim 1, wherein the data pre-processing unit generates the data set by augmenting a reflected signal generated with respect to a corresponding floor when ultrasonic waves are radiated toward the sample.

3. The non-destructive inspection system of claim 2, wherein the data pre-processing unit
augments the reflected signal by changing amplitude of the reflected signal through a random scaling factor, and
synthesizes the reflected signal with a random location of the scan data.

4. The non-destructive inspection system of claim 3, wherein the denoising autoencoder comprises:
an encoder configured to receive and compress the scan data comprising the original signal “x” and the defect signal “y” added to the original signal “x” in a cutpaste way; and
a decoder configured to output a compressed vector “z” as output data having a size identical with a size of the scan data.

5. The non-destructive inspection system of claim 4, wherein a loss function of the denoising autoencoder is represented as an equation below.
$${min}_{φ , ψ} ( ℒ ) = {min}_{φ , ψ} ( \vert {g}_{ψ} \{ {f}_{φ} ( x + y ) \} - x \vert + \vert ( x + y - {g}_{ψ} \{ {f}_{φ} ( x + y ) \} - y \vert ) = {min}_{φ , ψ} ( \vert {g}_{ψ} \{ {f}_{φ} ( x + y ) \} - x \vert )$$
wherein “x” denotes the original signal. “y” denotes the defect signal. “x+y” denotes a signal to which the defect is arbitrarily applied. “f” denotes the encoder. “g” denotes the decoder. “φ and ø” denote parameters of the encoder and the decoder, respectively.

6. The non-destructive inspection system of claim 5, wherein the defect prediction unit
calculates an average of absolute values of the defect signal, and
determines the defect signal to be the defect when the calculated average of the absolute values is greater than a statistical threshold “μ+3σ”.

7. The non-destructive inspection system of claim 6, wherein:
the defect prediction unit calculates the depth of the defect through time of flight (TOF) with respect to the defect signal determined as the defect, and
the TOF is calculated by an equation below.
$$TOF = arg max ( \vert ( x - {g}_{ψ} ( {f}_{φ} ( x ) ) \vert ) .$$

8. A non-destructive inspection method for an inspection object using a non-destructive inspection system based on self-supervised learning, the non-destructive inspection method comprising:
generating a plurality of data sets each comprising an original signal generated by scanning a sample and an arbitrary defect signal assigned to the original signal;
training a defect comprising a denoising autoencoder so that the defect analysis model outputs an original signal from which the defect signal has been removed by inputting the plurality of data sets to the defect analysis model;
outputting a defect signal through a residual operation of the original signal output by the defect analysis model and input scan data for an inspection object by inputting the scan data to the defect analysis model for which training has been completed; and
predicting a location and depth of a defect on the inspection object by applying a statistical threshold to the defect signal.

9. The non-destructive inspection method of claim 8, wherein the generating of the plurality of data sets each comprising the original signal generated by scanning the sample and the arbitrary defect signal assigned to the original signal comprises:
generating a reflected signal of a corresponding floor by radiating ultrasonic waves toward the sample;
augmenting the reflected signal by changing amplitude of the reflected signal through a random scaling factor; and
synthesizing the reflected signal with a random location of the original signal.

10. The non-destructive inspection method of claim 9, wherein the denoising autoencoder comprises:
an encoder configured to receive and compress the scan data comprising the original signal “x” and the defect signal “y” added to the original signal “x” in a cutpaste way; and
a decoder configured to output a compressed vector “z” as output data having a size identical with a size of the scan data.

11. The non-destructive inspection method of claim 10, wherein a loss function of the denoising autoencoder is represented as an equation below.
$${min}_{φ , ψ} ( ℒ ) = {min}_{φ , ψ} ( \vert {g}_{ψ} \{ {f}_{φ} ( x + y ) \} - x \vert + \vert ( x + y - {g}_{ψ} \{ {f}_{φ} ( x + y ) \} - y \vert ) = {min}_{φ , ψ} ( \vert {g}_{ψ} \{ {f}_{φ} ( x + y ) \} - x \vert )$$
wherein “x” denotes the original signal. “y” denotes the defect signal. “x+y” denotes a signal to which the defect is arbitrarily applied. “f” denotes the encoder. “g” denotes the decoder. “φ and ø” denote parameters of the encoder and the decoder, respectively.

12. The non-destructive inspection method of claim 10, wherein the predicting of the location and depth of the defect on the inspection object by applying the statistical threshold to the defect signal comprises:
calculating an average of absolute values of the defect signal, and
determining the defect signal to be the defect when the calculated average of the absolute values is greater than a statistical threshold “μ+3σ”.

13. The non-destructive inspection method of claim 12, further comprising calculating the depth of the defect through time of flight (TOF) with respect to the defect signal determined as the defect, after the determining of the defect signal to be the defect when the calculated average of the absolute values is greater than the statistical threshold “μ+3σ”,
wherein the TOF is calculated by an equation below.
$$TOF = arg max ( \vert ( x - {g}_{ψ} ( {f}_{φ} ( x ) ) \vert ) .$$
